(19) United States
(12) Patent Application Publication
(10) Pub. No.: US 2010/0026759 A1
(43) Pub. Date: Feb. 4, 2010

(54) LIQUID EJECTING HEAD AND LIQUID EJECTING APPARATUS

(75) Inventors: Yoshihiro KOBAYASHI, Matsumoto-shi (JP); Makoto KAWAMOTO, Matsumoto-shi (JP); Masato MITSUHASHI, Hara-mura (JP)

Correspondence Address: Workman Nydegger;1000 Eagle Gate Tower, 60 East South Temple, Salt Lake City, UT, 84111, US

(73) Assignee: SEIKO EPSON CORPORATION, Tokyo (JP)

(21) Appl. No.: 12/511,911

(22) Filed: Jul. 29, 2009

(30) Foreign Application Priority Data
Jul. 30, 2008 (JP) 2008-196913

(51) Int. Cl. B41J 2/145

(52) U.S. Cl. 347/40

(57) ABSTRACT

A liquid ejecting head includes: a head body that includes a plurality of nozzles and ejects liquid drops from the nozzles; a frame that supports the head body; a fixation plate by means of which the head body is fixed to the frame; and a holding plate that applies holding pressure to the fixation plate toward the frame so that the fixation plate is fixed to the frame.

### BACKGROUND

1. Technical Field

The present invention relates to a liquid ejecting head that includes at least one head body that ejects liquid drops from nozzles thereof and a frame that supports the head body, which is fixed to the frame by means of at least one fixation plate. The invention further relates to a liquid ejecting apparatus that is provided with such a liquid ejecting head.

2. Related Art

A liquid ejecting apparatus is provided with a liquid ejecting head that is capable of ejecting liquid in the form of liquid drops. As a typical example of a liquid ejecting apparatus, an ink-jet recording apparatus such as an ink-jet printer, an ink-jet plotter, and the like ejects ink that is supplied from ink containers such as ink cartridges, ink tanks, or the like.

There is a demand for such a liquid ejecting head used in a liquid ejecting apparatus that has a high nozzle array density and a long nozzle line. However, it is practically difficult or disadvantageous to increase the nozzle array density and the nozzle line with a single head body structure because the yield rate of a head body, that is, the yield rate of a head component, decreases and further because the production cost thereof increases. In order to overcome these disadvantages, a liquid ejecting head that includes a plurality of head bodies and a frame has been proposed, for example, as disclosed in International Publication Brochure No. 2004/022344 (refer to Page 6, FIGS. 4 and 5). Specifically, in the configuration of a liquid ejecting head disclosed in WO 2004/022344, the plurality of head bodies is fixed to the frame, which is a common support plate, so as to form a modularized head, that is, a composite part.

In the configuration of such a liquid ejecting head of the related art, fixation plates are fixed to each head body. Then, the fixation plates are fixed to the frame by means of screws so as to fix the plurality of head bodies to the frame.

However, if each head body is fixed to the frame by fastening screws through the fixation plates fixed to the head body and into the frame after the positional determination of the head body with respect to the frame with high precision, the rotation force of the screw that is applied at the time of fastening thereof causes the fixation plate to turn. As a result of the turning of the fixation plate, a problem arises in that the position of the head body that has been determined with high precision becomes shifted, which means that misalignment in head position occurs.

The problem explained above is not unique to an ink-jet recording head that ejects ink. That is, the same problem could occur in various kinds of other liquid ejecting heads that eject liquid other than ink.

### SUMMARY

An advantage of some aspects of the invention is to provide a liquid ejecting head that makes it possible to fix a plurality of head bodies, or a single head body, to a frame with high positional precision, thereby enhancing print quality. In addition, the invention further relates to, as an advantage of some aspects thereof, a liquid ejecting apparatus that is provided with such a liquid ejecting head.

In order to address the above-identified problem without any limitation thereto, a liquid ejecting head according to a first aspect of the invention includes: a head body that includes a plurality of nozzles and ejects liquid drops from the nozzles; a frame that supports the head body; a fixation plate by means of which the head body is fixed to the frame; and a holding plate that applies holding pressure to the fixation plate toward the frame so that the fixation plate is fixed to the frame.

With such a structure, in comparison with a case where the fixation plate is directly fixed to the frame by screwing a fixation screw through the fixation plate, it is possible to substantially reduce the risk of the positional misalignment of the head body with respect to the frame.

It is preferable that the liquid ejecting head according to the first aspect of the invention described above should further include a holding plate fixation screw and at least two washers, wherein the holding plate is fixed to the frame by means of the holding plate fixation screw; at least two washers mentioned above are provided between the holding plate and the holding plate fixation screw; and a coefficient of friction between one of the two washers and the other thereof is smaller than a coefficient of friction between the one washer and the holding plate, and in addition, is smaller than a coefficient of friction between the other washer and the holding plate fixation screw. With such a preferred structure, low-friction rotation occurs between the two washers at the time when the holding plate fixation screw is screwed for fixation. That is, the one of these two washers and the other thereof function as a kind of a buffer that absorbs and reduces a rotation force that acts at the time when the holding plate fixation screw is screwed for fixation, which means that the rotation force is substantially less likely to be transmitted to the holding plate. Therefore, it is possible to reduce the occurrence of the turning of the holding plate. Thus, it is possible to further reduce the risk of the positional misalignment of the head body with respect to the frame.

It is preferable that the liquid ejecting head having the preferred structure explained above should further include a fixation plate fixation screw, wherein the holding plate is fixed to the frame by means of the holding plate fixation screw; and the fixation plate is fixed to the frame by means of the fixation plate fixation screw. With such a preferred structure, since the fixation plate is fixed to the frame with the use of the fixation plate fixation screw, even in a case where the holding plate fixation screw has become loosened as time elapses because of a small coefficient of friction between the two washers, it is possible to prevent the fixation plate, which is fixed to the head body, from becoming unfastened from the frame. Furthermore, with such a preferred structure, it is possible to remove the head body from the frame easily just by loosening the fixation plate fixation screw(s) and the holding plate fixation screw(s).

In order to address the above-identified problem without any limitation thereto, the invention provides, as a second aspect thereof, a liquid ejecting apparatus that is provided with the liquid ejecting head according to the first aspect of the invention described above.

Since a plurality of head bodies, or a single head body, is fixed to a frame with high positional precision, a liquid ejecting apparatus according to the second aspect of the invention described above achieves enhanced print quality.

### BRIEF DESCRIPTION OF THE DRAWINGS

The invention will be described with reference to the accompanying drawings, wherein like numbers reference like elements.

FIG. 1 is a perspective view that schematically illustrates an example of the configuration of an ink-jet recording head that is an example of various kinds of liquid ejecting heads according to a first embodiment of the invention.

FIG. 2 is a plan view that schematically illustrates an example of the configuration of the ink-jet recording head that is viewed from the nozzle side thereof.

FIG. 3A is a plan view that schematically illustrates an example of an essential part of the ink-jet recording head that is viewed from the other side that is opposite to the nozzle side thereof.

FIG. 3B is a sectional view taken along the line IIIB-IIIB of FIG. 3A.

FIG. 4A is a sectional view that schematically illustrates an example of an essential part of an ink-jet recording head that is an example of various kinds of liquid ejecting heads according to a second embodiment of the invention.

FIG. 4B is an enlarged sectional view that schematically illustrates an example of a screw-fastening structure of the ink-jet recording head illustrated in FIG. 4A.

FIG. 5 is a plan view that schematically illustrates an example of an essential part of an ink-jet recording head that is an example of various kinds of liquid ejecting heads according to a third embodiment of the invention.

FIG. 6 is a perspective view that schematically illustrates an example of the configuration of an ink-jet recording apparatus that is provided with an ink-jet recording head according to an exemplary embodiment of the invention.

### DESCRIPTION OF EXEMPLARY EMBODIMENTS

With reference to the accompanying drawings, exemplary embodiments of the present invention will now be explained in detail.

### First Embodiment

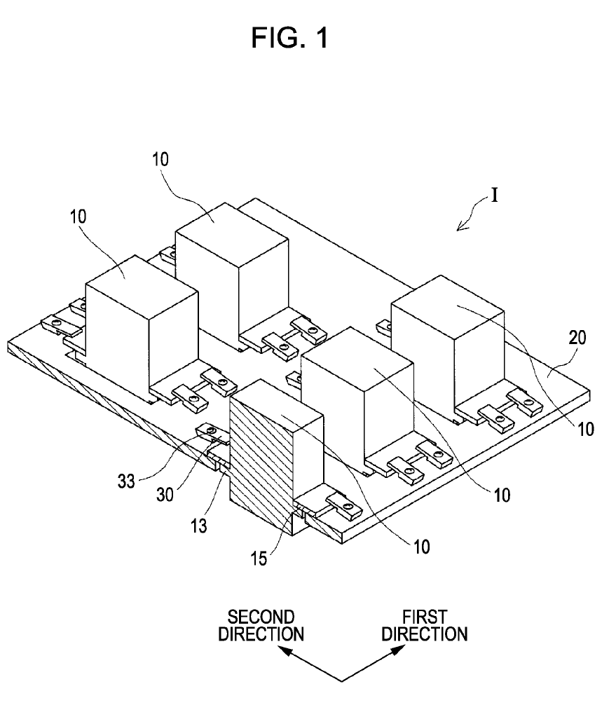

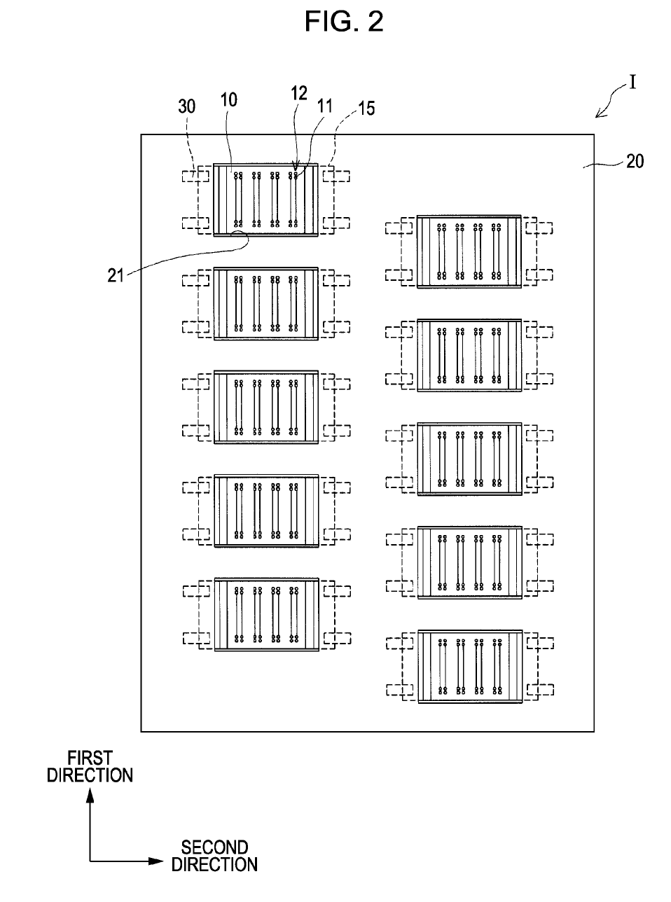

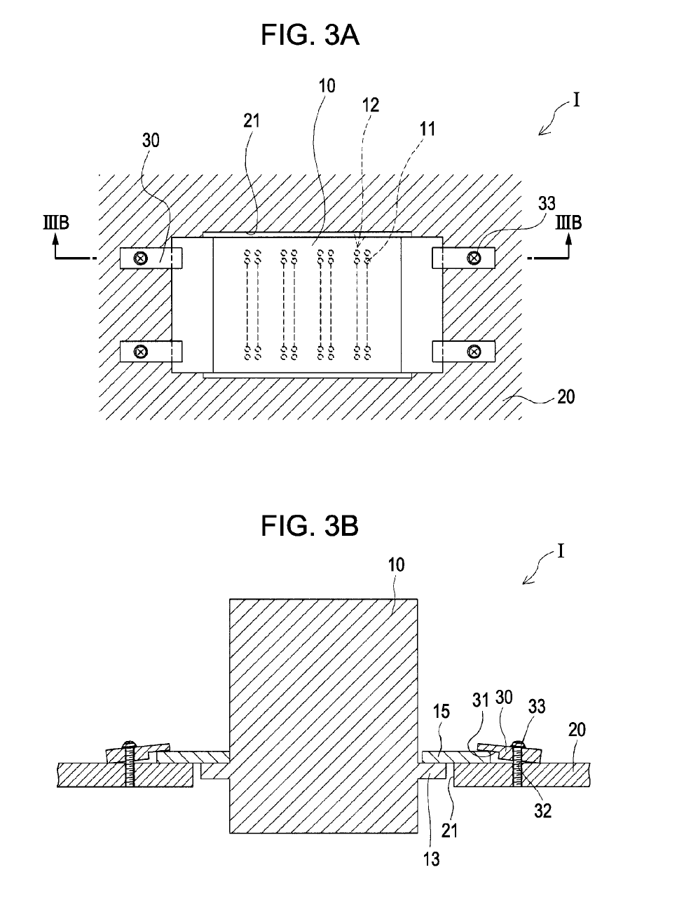

FIG. 1 is a perspective view that schematically illustrates an example of the configuration of an ink-jet recording head that is an example of various kinds of liquid ejecting heads according to a first embodiment of the invention. FIG. 2 is a plan view that schematically illustrates an example of the configuration of the ink-jet recording head that is viewed from the nozzle side thereof. FIG. 3A is a plan view that schematically illustrates an example of an essential part of the ink-jet recording head that is viewed from the other side that is opposite to the nozzle side thereof. FIG. 3B is a sectional view taken along the line IIIB-IIIB of FIG. 3A.

As illustrated in these drawings, an ink-jet recording head I according to the present embodiment of the invention is provided with a plurality of head “bodies” 10 and a frame 20. The term “head bodies” means, for example, the head components of the ink-jet recording head I without any limitation thereto. After the positional adjustment thereof, the plurality of head bodies 10 is fixed to the frame 20 so as to make up the ink-jet recording head I. In the configuration of the ink-jet recording head I according to the present embodiment of the invention, the plurality of head bodies 10 is fixed to the frame 20 in a staggered array layout.

Each of the head bodies 10 according to the present embodiment of the invention is provided with plural sets of nozzle lines 12, each set of which is made up of at least one nozzle line 12. For example, each of the head bodies 10 is provided with plural sets of paired nozzle lines 12 that are formed next to and in parallel with each other. The nozzle lines 12 are formed on one end face of the head body 10. Each nozzle line 12 is made up of a plurality of nozzles 11 that are arrayed adjacent to one another so as to form a straight line. The number of nozzle lines 12 that make up each set is not restrictively specified in this specification. For example, the plurality of nozzles 11 may be arrayed so as to form a single nozzle line 12 for each set. Or, the number of nozzle lines 12 that make up each set may be two or greater. In the illustrated nozzle layout according to the present embodiment of the invention, the nozzles 11 are arrayed adjacent to one another with a predetermined array density, for example, with a 180 dpi array pitch, so as to form a pair of straight nozzle lines 12 that are provided next to and in parallel with each other for each set. Each of the head bodies 10 is provided with four sets of the paired nozzle lines 12, that is, eight nozzle lines 12. Color ink of a plurality of colors and black ink are ejected from these sets of the paired nozzle lines 12, respectively. The number of sets of the nozzle lines 12 is not limited to four. That is, the number of sets of the nozzle lines 12 may be arbitrarily determined depending on, for example, the number of colors of ink inclusive of black ink that is to be ejected from the head body 10.

In the following description of this specification, the direction along which the nozzles 11 are arrayed adjacent to one another so as to form the nozzle line 12 is defined as a first direction. In other words, the direction in which each nozzle line 12 extends is defined as the first direction. The direction orthogonal to the first direction is defined as a second direction. Therefore, eight nozzle lines 12 are provided in parallel with one another when viewed in the second direction.

Though not shown in the drawings, pressure generation chambers and pressure generators are provided inside each head body 10. The pressure generation chamber, which is a pressure generation compartment, constitutes a part of an ink flow passage that leads to the nozzle 11. The pressure generation means causes a pressure change in the pressure generation chamber so as to eject ink from the nozzle 11. The type of the pressure generation means is not specifically limited herein. For example, a piezoelectric element that includes a piezoelectric material having an electro-mechanical transduction function and two electrodes that sandwich the piezoelectric material may be used as the pressure generation means. Or, the pressure generation means may be a heat type pressure generator that includes a heating element provided in the pressure generation chamber. An ink-jet recording head that is provided with such a heat-type pressure generation means discharges an ink drop from the nozzle 11 thereof by utilizing bubbles formed by heat generated by the heating element. Or, a static-electricity type pressure generator may be used as the pressure generation means. For example, static electricity is generated between a vibrating diaphragm and an electrode. The vibrating diaphragm becomes deformed because of the electrostatic force. As a result, an ink drop is discharged from the nozzle 11. There are various kinds of piezoelectric elements that can be used as the pressure generation means. For example, the pressure generation means may be a deflection-vibration type piezoelectric element that includes layers of a lower electrode, a piezoelectric material, and an upper electrode that are formed in the order of appearance herein as viewed from the pressure generation chamber. As another example, the pressure generation means may be a vertical vibration piezoelectric element that includes alternate layers of a piezoelectric material and an electrode formation material. The vertical-vibration type piezoelectric element expands and contracts in the axial direction thereof.

An ink flow passage through which ink is supplied from the outside to the head body 10 or drained from the head body 10 to the outside is connected to the other surface of the head body 10 that is opposite to the nozzle face thereof.

A flange part 13 protruding outward is formed on each of two side surfaces of the head body 10 that are opposite to each other when viewed in the second direction.

Fixation plates 15 are fixed to these two flange parts 13 protruding from the two side surfaces of the head body 10, respectively. In other words, in the configuration of the ink-jet recording head I according to the present embodiment of the invention, the fixation plate 15 is attached to each of the two flange parts 13 projecting outward in the second direction on the two opposite side surfaces of the head body 10. That is, two fixation plates 15 are provided for each head body 10. However, the number of the fixation plates 15 that are provided for each head body 10 is not limited to two. For example, a single fixation plate that includes two fixation parts may be provided for each head body 10. That is, only one fixation plate that has a hole through which the head body 10 can be inserted may be fixed to the two flange parts 13. Needless to say, two or more fixation plates may be fixed to each of the flange parts 13.

The method of the fixation of the fixation plate 15 and the head body 10 is not restrictively specified in this specification. For example, an adhesive, a screw(s), a rivet(s), or the like can be used for the fixation of the fixation plate 15 and the head body 10.

Since the fixation plate 15 is provided for fixing the head body 10 to the frame 20, it is preferable that the fixation plate 15 should be made of a material that has sufficient rigidity. For example, the fixation plate 15 is preferably made of hard resin, metal, or the like.

The head bodies 10 are fixed to the common frame 20 with the use of the fixation plates 15. Next, the structure of the frame 20 is explained below.

The frame 20 is a plate member that is made of metal, hard resin, or the like. As illustrated in FIG. 3, the frame 20 has a plurality of head body insertion holes 21 through each of which the nozzle-side part of the head body 10 is inserted. The head body insertion hole 21 may be hereafter referred to as “head body fixation hole” or simply as “fixation hole”. The opening size of each head body fixation hole 21 is slightly larger than the flanged external dimension of the nozzle-side part of the head body 10. However, the size of the head body insertion hole 21 is small enough so that the fixation plates 15 cover the plate-side parts of the opening. As illustrated in FIGS. 3A and 3B as well as FIG. 1, the frame 20 supports the head body 10 with the nozzle-side part thereof being inserted through the head body insertion hole 21. When viewed in the second direction, each fixation plate 15 is fixed to the corresponding flange part 13 of the head body 10 at one side and to the hole-periphery area of the frame 20 near the head body fixation hole 21 at the other side so that the frame 20 supports the head body 10. As further illustrated therein, a clearance is formed between the head body 10 and the head body fixation hole 21. Because of such a clearance, each head body 10 is allowed to move slightly, for example, for positional adjustment, in the first direction and the second direction with respect to the frame 20. The frame 20 supports the plurality of the head bodies 10 after the positional determination of the plurality of nozzle lines 12 thereof.

In the configuration of the ink-jet recording head I according to the present embodiment of the invention, as a means for fixing the head body 10 to the frame 20, a plurality of holding plates 30 is provided at the hole-periphery area of the frame 20 near the head body fixation hole 21 outside the fixation plates 15 when viewed in the second direction. The holding plate 30 applies holding pressure to the fixation plate 15 toward the frame 20. The fixation plate 15 is pinched, that is, cramped, between the holding plate 30 and the frame 20. By this means, the fixation plate 15 is fixed to the frame 20.

The holding plate 30 is a plate member that is made of metal, hard resin, or the like. In the illustrated configuration example, two holding plates 30 are provided for each of the two fixation plates 15 provided for the head body 10. That is, four holding plates 30 are provided for each head body 10.

Each holding plate 30 has a thin part 31 at the front-end side thereof. Therefore, there is a surface level difference between the thin part 31 of the holding plate 30 and the other non-front part thereof. The dimension of the level difference is smaller than the thickness of the fixation plate 15. Accordingly, the thin part 31 of the holding plate 30 is in contact with the surface of the fixation plate 15 so as to fix the fixation plate 15 to the frame 20.

The holding plate 30 has a holding plate fixation hole 32 at the base-end side thereof. The holding plate fixation hole 32 is a threaded hole. A holding plate fixation screw 33 is screwed through the holding plate fixation hole 32 and into a threaded hole of the frame 20 so as to fix the holding plate 30 to the frame 20.

As explained above, the thin part 31 is formed at the front-end side of each holding plate 30. Accordingly, when the thin part 31 of the holding plate 30 is placed in contact with the surface of the fixation plate 15 that is placed partially on the surface of the frame 20 at one plate-edge side thereof, the front-end part of the holding plate 30 is relatively distanced from the frame 20 with a certain inclination, which might be referred to as “a front-ungrounded bridge state” (refer to FIG. 3B) in this specification. The holding plate fixation screw 33 is screwed through the holding plate fixation hole 32 and into a threaded hole of the frame 20 with the holding plate 30 being set in such a front-ungrounded bridge state. Under the screw-fastening force of the holding plate fixation screw 33, the holding plate 30 applies holding pressure to the fixation plate 15 toward the frame 20. Accordingly, the fixation plate 15 is pinched between the holding plate 30 and the frame 20. By this means, it is possible to fix the head body 10 to the frame 20.

In addition, with such a structure, it is possible to avoid a difficulty in fastening the holding plate fixation screw 33 securely despite the fact that the surface of the holding plate 30 at the screw-head side is inclined. That is, since the holding plate 30 has the thin part 31 at the front-end side thereof, the surface of the holding plate 30 is less inclined than otherwise even though the fixation plate 15 has some thickness. When the surface of the holding plate 30 is slanted, a gap is formed between the screw head of the holding plate fixation screw 33 and the inclined surface of the holding plate 30. The holding plate fixation screw 33 is more likely to become loosened because of such a gap, which is not desirable, in comparison with a case where there is no gap therebetween. In this respect, in the configuration of the ink-jet recording head I according to the present embodiment of the invention, the angle of surface inclination is relatively small because the holding plate 30 has the level difference 31. Therefore, the fixation performance of the holding plate fixation screw 33 is not impaired. Although it is explained above that the holding plate 30 has the thin part 31 at the front-end side thereof so as to provide a level difference, the scope of this aspect of the invention is not limited to such an exemplary structure. For example, a level-difference structure may be formed at an area of the frame 20 where the fixation plate 15 is to be placed. Any alternative level-difference structure may be adopted as long as it contributes to a reduction of the angle of surface inclination of the holding plate 30.

Since the fixation plate 15 is fixed to the frame 20 with the use of, and under the holding pressure applied by, the holding plate 30, it is possible to prevent a rotation force that acts at the time when the fixation screw 33 is screwed for fixation from being directly applied to the fixation plate 15. That is, although a rotation force acts at the time when the holding plate fixation screw 33 is screwed for fixation in such a direction in which the holding plate 30 turns, the holding plate 30 does not actually turn easily because of frictional resistance between the holding plate 30 and the frame 20. Even when the holding plate 30 actually turns due to the rotation force applied thereto, and further when the turning force of the holding plate 30 is transmitted to the fixation plate 15, the fixation plate 15 does not actually turn easily because of frictional resistance between the fixation plate 15 and the frame 20. As explained above, the holding plate fixation screw 33 is screwed through the holding plate fixation hole 32 of the holding plate 30 and into a threaded hole of the frame 20. Under the screw-fastening force of the holding plate fixation screw 33, the holding plate 30 applies holding pressure to the fixation plate 15 toward the frame 20 so that the fixation plate 15 is pinched between the holding plate 30 and the frame 20. Since the fixation plate 15 is fixed to the frame 20 with the use of the holding plate 30 as explained above, the holding plate 30 functions as a kind of a buffer that absorbs, for example, resists against, and reduces the rotation force that acts at the time when the holding plate fixation screw 33 is screwed for fixation. Therefore, in comparison with a case where the fixation plate 15 is directly fixed to the frame 20 by screwing the fixation screw 33 through the fixation plate 15, it is possible to substantially reduce the risk of the turning of the fixation plate 15. For this reason, it is possible to reduce the occurrence of misalignment or any undesirable shift in the position of the unfixed head body 10, which has been determined with high positional precision, with respect to the frame 20 when the head body 10 is fixed to the frame 20. Thus, it is possible to fix the head body 10 to the frame 20 with high positional precision.

In the head array layout of the ink-jet recording head I according to the present embodiment of the invention, the head bodies 10 are arrayed to form two lines, one of which is made up of five head bodies 10 that are aligned in the first direction, which is the direction along which the nozzles 11 are arrayed adjacent to one another so as to form the nozzle line 12 as defined earlier. The other of the two lines is also made up of another five head bodies 10 aligned in the first direction. When viewed in the second direction, the first-mentioned line of five head bodies 10 and the second-mentioned line of five head bodies 10 are provided in parallel with each other. This means that ten head bodies 10 are arrayed through the frame 20 as explained above.

As explained earlier, each nozzle line 12 that is made up of the plurality of nozzles 11 extends in the first direction. The plurality of head bodies 10 is arrayed in a staggered or zigzag layout with alternating spaces therebetween. In addition, the plurality of head bodies 10 is arrayed in such a manner that the plurality of the nozzle lines 12 is “virtually connected from one to another” in the first direction. With such a staggered layout, it is possible to form successive nozzle lines 12 that are “virtually connected from one to another” in the first direction by means of ten head bodies 10 so as to have an aggregate nozzle-line length that is ten times as great as the length of the nozzle line 12 of a single head body 10. By this means, it is possible to perform printing at a broader area and at a higher speed in comparison with a case where printing is performed with the use of the nozzle line 12 of one head body 10 only.

In the preceding paragraph, it is explained that the nozzle lines 12 of the head bodies 10 are “virtually connected from one to another” in the first direction. This means that the last nozzle 11 provided at an end of the nozzle line 12 of one of any two head bodies 10 that are “obliquely adjacent” to each other when viewed in the second direction in the staggered layout lies at the same first-directional position as that of the first nozzle 11 provided at the opposite-side end of the nozzle line 12 of the other head body 10, which is the next head body. In other words, it can be said that the last nozzle 11 mentioned above is located at the same position when viewed in the first direction as that of the first nozzle 11 mentioned above if a positional difference therebetween when viewed in the second direction is disregarded. The positional relation explained above applies to all head bodies 10 fixed to the frame 20.

As explained in detail above, in the configuration of the ink-jet recording head I according to the first embodiment of the invention, the holding plate 30 is fixed to the frame 20 by means of the holding plate fixation screw 33. Under the screw-fastening force of the holding plate fixation screw 33, the holding plate 30 applies holding pressure to the fixation plate 15 toward the frame 20 so that the fixation plate 15 is pinched between the holding plate 30 and the frame 20. Since the fixation plate 15 fixed to the flange part 13 of the head body 10 at one plate-edge side is fixed to the frame 20 at the other plate-edge side with the use of the holding plate 30, the rotation force that acts at the time when the fixation screw 33 is screwed for fixation is not directly applied to the fixation plate 15. That is, the holding plate 30 functions as a kind of a buffer that absorbs and reduces a rotation force that acts at the time when the holding plate fixation screw 33 is screwed for fixation. By this means, in comparison with a case where the fixation plate 15 is directly fixed to the frame 20, it is possible to substantially reduce the risk of the turning of the fixation plate 15. For this reason, it is possible to reduce the occurrence of misalignment or any undesirable shift in the position of the unfixed head body 10, which has been determined with high positional precision, with respect to the frame 20 when the head body 10 is fixed to the frame 20. Thus, it is possible to fix the plurality of head bodies 10 to the frame 20 with high precision in the relative positions thereof, which results in high print quality.

Moreover, since the holding plate 30 is fixed to the frame 20 with the use of the holding plate fixation screw 33, it is possible to remove the head body 10 from the frame 20 just by loosening the holding plate fixation screws 33 at the time when, for example, it is necessary to repair the head body 10 or replace the head body 10 with new one. Therefore, it is easy to perform the repair, replacement, or other maintenance work of the head body 10.

### Second Embodiment

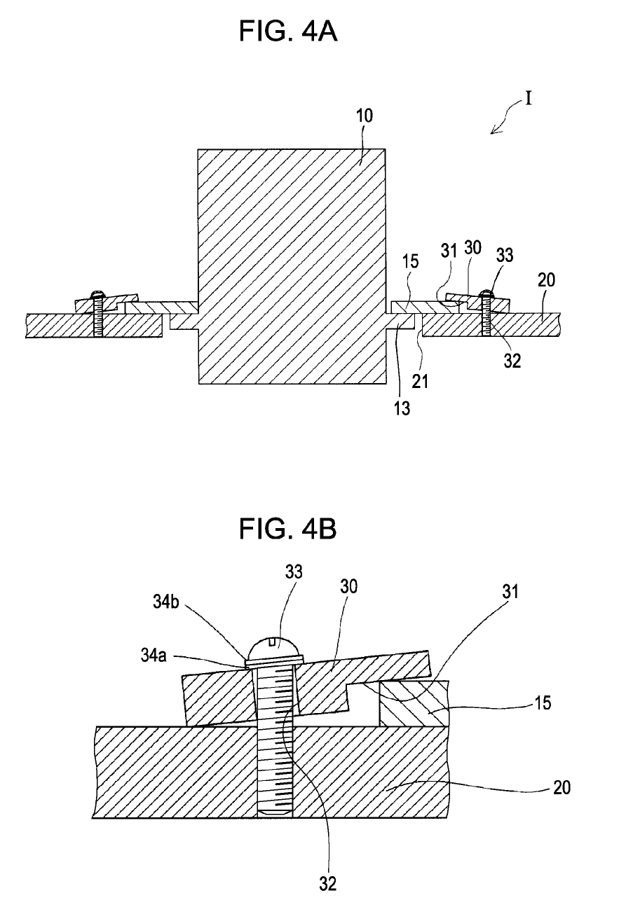

FIG. 4A is a sectional view that schematically illustrates an example of an essential part of an ink-jet recording head that is an example of various kinds of liquid ejecting heads according to a second embodiment of the invention. FIG. 4B is an enlarged sectional view that schematically illustrates an example of a screw-fastening structure of the ink-jet recording head illustrated in FIG. 4A. In the following description of an ink-jet recording head according to the second embodiment of the invention, the same reference numerals are consistently used for the same components as those of the ink-jet recording head according to the first embodiment of the invention so as to omit any redundant explanation or simplify explanation thereof.

In the configuration of the ink-jet recording head I according to the foregoing first embodiment of the invention, the holding plate 30 is fixed to the frame 20 by means of the holding plate fixation screw 33. Under the screw-fastening force of the holding plate fixation screw 33, the holding plate 30 applies holding pressure to the fixation plate 15 toward the frame 20 so that the fixation plate 15 is pinched between the holding plate 30 and the frame 20. The fixation plate 15 fixed to the flange part 13 of the head body 10 at one plate-edge side is fixed to the frame 20 at the other plate-edge side with the use of the holding plate 30. The configuration of the ink-jet recording head I according to the second embodiment of the invention differs from that of the ink-jet recording head I according to the foregoing first embodiment of the invention in that the holding plate 30 is fixed to the frame 20 by means of two washers 34a and 34b, at least one of which is a low-friction washer, as well as the holding plate fixation screw 33 as illustrated in FIG. 4B. That is, in the configuration of the ink-jet recording head I according to the second embodiment of the invention, two washers 34a and 34b are provided between the holding plate 30 and the screw head of the holding plate fixation screw 33.

The term “low-friction washer” is defined in this specification as follows. A coefficient of friction between one washer 34a and the other washer 34b is smaller than a coefficient of friction between one washer 34a mentioned above and the holding plate 30. In addition, the coefficient of friction between one washer 34a mentioned above and the other washer 34b mentioned above is smaller than a coefficient of friction between the other washer 34a mentioned above and the holding plate fixation screw 33. It is possible to ensure that the coefficient of friction between the one washer 34a and the other washer 34b is smaller than the coefficient of friction between the one washer 34a and the holding plate 30 and, in addition thereto, is smaller than the coefficient of friction between the other washer 34a and the holding plate fixation screw 33 by using two low-friction washers made of a material that has a relatively low coefficient of friction as in the configuration of the ink-jet recording head I according to the present embodiment of the invention.

Alternatively, for example, a low-friction washer made of a material that has a relatively low coefficient of friction may be used for the one washer 34a only. Such a single low-friction washer structure may be adopted as long as the coefficient of friction between the one washer 34a, which is made of a material that has a relatively low coefficient of friction, and the other washer 34b is smaller than the coefficient of friction between the one washer 34a and the holding plate 30 and, in addition thereto, is smaller than the coefficient of friction between the other washer 34a and the holding plate fixation screw 33.

Furthermore, the smoothness of the surfaces of the one washer 34a and the other washer 34b may be adjusted so as to ensure that the coefficient of friction between the one washer 34a and the other washer 34b is smaller than the coefficient of friction between the one washer 34a and the holding plate 30 and is smaller than the coefficient of friction between the other washer 34a and the holding plate fixation screw 33. That is, for example, it is possible to ensure that the coefficient of friction between the one washer 34a and the other washer 34b is smaller than the coefficient of friction between the one washer 34a and the holding plate 30 and is smaller than the coefficient of friction between the other washer 34a and the holding plate fixation screw 33 by smoothening the surfaces the one washer 34a and the other washer 34b that are in contact with each other without smoothening the other opposite surfaces thereof.

As explained in detail above, in the configuration of the ink-jet recording head I according to the second embodiment of the invention, the holding plate 30 is fixed to the frame 20 by means of the two washers 34a and 34b that have a relatively small coefficient of friction therebetween as well as the holding plate fixation screw 33. Under the screw-fastening force of the holding plate fixation screw 33, the holding plate 30 applies holding pressure to the fixation plate 15 toward the frame 20 so that the fixation plate 15 is pinched between the holding plate 30 and the frame 20. Since the fixation plate 15 fixed to the flange part 13 of the head body 10 at one plate-edge side is fixed to the frame 20 at the other plate-edge side with the use of the holding plate 30, which is fixed by means of the holding plate fixation screw 33 with the two washers 34a and 34b being provided between the holding plate 30 and the screw head of the holding plate fixation screw 33, sliding rotation occurs between the two washers 34a and 34b at the time when the holding plate fixation screw 33 is screwed for fixation. That is, the pair of washer 34a and 34b functions as a kind of a buffer that absorbs and reduces a rotation force that acts at the time when the holding plate fixation screw 33 is screwed for fixation. Therefore, it is possible to reduce the occurrence of the turning of the holding plate 30. For this reason, it is possible to reduce, with greater reliability, the occurrence of misalignment or any undesirable shift in the position of the unfixed head body 10, which has been determined with high positional precision, with respect to the frame 20 when the head body 10 is fixed to the frame 20. Thus, it is possible to fix the head body 10 to the frame 20 with higher positional precision.

Note that the structure explained above is more vulnerable to vibration or the like, which might cause the loosening of the holding plate fixation screw 33. That is, since the coefficient of friction between the two washers 34a and 34b is small, there is a possibility that the holding plate fixation screw 33 becomes loosened due to vibration or other reasons with the passage of time. Therefore, it is preferable to additionally fix the holding plate fixation screw 33 to the frame 20 or the holding plate 30 by means of an anti-loosening agent, an adhesive, or the like. With such preferred fixation, it is possible to prevent the holding plate fixation screw 33 from becoming loosened as time elapses. That is, the anti-loosening fixation ensures that the holding plate 30 applies holding pressure to the fixation plate 15 toward the frame 20 so that the fixation plate 15 is securely pinched between the holding plate 30 and the frame 20 even though the coefficient of friction between the two washers 34a and 34b is small. Thus, the head body 10 is fixed to the frame 20 securely.

In the foregoing description of the present embodiment of the invention, it is explained that the two washers 34a and 34b, at least one of which is a low-friction washer, are provided between the holding plate 30 and the screw head of the holding plate fixation screw 33. However, the number of washers provided between the holding plate 30 and the screw head of the holding plate fixation screw 33 is not limited to two. For example, three or more washers may be provided between the holding plate 30 and the screw head of the holding plate fixation screw 33. Such a triple washer structure or a multi-layered washer structure may be adopted as long as one of three or more washers that are stacked on top of one another offers such a coefficient of friction that is smaller than a coefficient of friction between the holding-plate-side washer, which is in contact with the holding plate 30, and the holding plate 30 and, in addition thereto, is smaller than a coefficient of friction between the screw-head-side washer, which is in contact with the screw head of the holding plate fixation screw 33, and the holding plate fixation screw 33.

### Third Embodiment

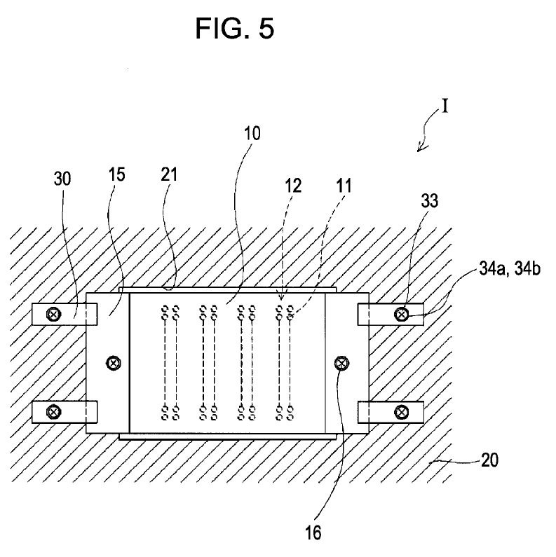

FIG. 5 is a plan view that schematically illustrates an example of an essential part of an ink-jet recording head that is an example of various kinds of liquid ejecting heads according to a third embodiment of the invention. In the following description of an ink-jet recording head according to the third embodiment of the invention, the same reference numerals are consistently used for the same components as those of the ink-jet recording head according to the first embodiment of the invention or those of the ink-jet recording head according to the second embodiment of the invention so as to omit any redundant explanation or simplify explanation thereof.

As illustrated in FIG. 5, the ink-jet recording head I according to the third embodiment of the invention is provided with the two washers 34a and 34b provided between the holding plate 30 and the screw head of the holding plate fixation screw 33, which is the same structure as that of the ink-jet recording head I according to the second embodiment of the invention explained above. As a characteristic feature of the ink-jet recording head I according to the third embodiment of the invention, the fixation plate 15 is fixed to the frame 20 not only with the use of the holding plates 30 but also with the use of a fixation-plate fixation screw 16.

In the illustrated configuration example, one fixation-plate fixation screw 16 is provided at the center of each of the two fixation plates 15 provided for the head body 10. That is, two fixation-plate fixation screws 16 are provided for each head body 10. However, the number of the fixation-plate fixation screws 16 that are provided for each head body 10 is not limited to two. Nor is the screw-fastening position of the fixation-plate fixation screw 16 limited to the center of each of the two fixation plates 15. That is, the number of the fixation-plate fixation screws 16 and the screw-fastening position(s) thereof may be arbitrarily determined as long as they do not obstruct the holding of the holding plate 30 while ensuring that misalignment or any undesirable shift in the position of the head body 10 with respect to the frame 20 does not occur.

Since the fixation plate 15 is directly fixed to the frame 20 with the use of the fixation-plate fixation screw 16, a rotation force that acts at the time when the fixation-plate fixation screw 16 is screwed for fixation is directly applied to the fixation plate 15. However, if the fixation plate 15 has been pre-fixed with the use of the holding plates 30 before the fixation-plate fixation screw 16 is screwed through the fixation plate 15 for fixation, it is possible to prevent the fixation plate 15 from becoming turned and/or shifted undesirably due to the rotation force of the fixation-plate fixation screw 16.

That is, as a preliminary fixation process of the ink-jet recording head I according to the third embodiment of the invention, the holding plate 30 is fixed to the frame 20 by means of the holding plate fixation screw 33. Under the screw-fastening force of the holding plate fixation screw 33, the holding plate 30 applies holding pressure to the fixation plate 15 toward the frame 20 so that the fixation plate 15 is pinched between the holding plate 30 and the frame 20, which provides tentative fixation. Thereafter, as a non-tentative fixation process thereof, the fixation-plate fixation screw 16 is screwed through the fixation plate 15 so as to securely fix the fixation plate 15 to the frame 20.

Since the fixation plate 15 is non-tentatively fixed to the frame 20 with the use of the fixation-plate fixation screw 16, even in a case where the holding plate fixation screw 33 has become loosened as time elapses because of a small coefficient of friction between the two washers 34a and 34b, it is possible to prevent the fixation plate 15, which is fixed to the flange part 13 of the head body 10 at one plate-edge side, from becoming unfastened from the frame 20.

Moreover, since each fixation plate 15 is non-tentatively fixed to the frame 20 by means of a single fixation-plate fixation screw 16 in the illustrated structure example, it is possible to remove the head body 10 from the frame 20 just by loosening the fixation-plate fixation screws 16 and the holding plate fixation screws 33 at the time when, for example, it is necessary to repair the head body 10 or replace the head body 10 with new one. Since the head body 10 can be removed from the frame 20 easily, it is easy to perform the repair, replacement, or other maintenance work of the head body 10.

### Other Embodiments

Although exemplary embodiments of the invention are explained above, needless to say, the basic configuration and the scope of the invention is in no case limited to any of the foregoing specific embodiments and examples. For example, in the configuration of the ink-jet recording head I according to each of the first, the second, and the third embodiments of the invention, it is explained that ten head bodies 10 are fixed to the frame 20. However, the number of the head bodies 10 that are fixed to the frame 20 is not limited to ten. In addition, the array positions of the head bodies 10 are not limited to the specific layout example explained above. As a modification example, the ink-jet recording head I may be provided with a single head body 10 fixed to the frame 20. Or, the ink-jet recording head I may be provided with a plurality of, which is larger than or smaller than ten, head bodies 10 fixed to the frame 20.

In the configuration of the ink-jet recording head I according to each of the first, the second, and the third embodiments of the invention, it is explained that the two fixation plates 15 are respectively fixed to the two flange parts 13 that protrude from the two side surfaces of the head body 10 that are opposite to each other when viewed in the second direction. However, the scope of this aspect of the invention is not limited to such an exemplary structure. For example, the two fixation plates 15 may be respectively fixed to the two flange parts 13 that protrude from the two side surfaces of the head body 10 that are opposite to each other when viewed not in the second direction but in the first direction. Although the fixation plates 15 may be fixed thereto in the first direction, the relative positions of any two head bodies 10 that are arrayed next to each other in the first direction so as to form a part of a first-directional head line is determined on the basis of the length of the nozzle line 12 in the configuration of the ink-jet recording head I according to each of the first, the second, and the third embodiments of the invention. For this reason, there is a possibility that a space between the two head bodies 10 that are arrayed next to each other in the first direction so as to form a part of the first-directional line is not wide enough. Therefore, it is advantageous to fix the fixation plates 15 respectively to the flange parts 13 that protrude from the two side surfaces of the head body 10 that are opposite to each other when viewed not in the first direction but in the second direction because the space that is required for the fixation of the fixation plate 15 does not affect the array positions of the head bodies 10.

In the configuration of the ink-jet recording head I according to each of the first, the second, and the third embodiments of the invention, it is explained that, the holding plate 30 is fixed to the frame 20 by means of, at least, the holding plate fixation screw 33. Under the screw-fastening force of the holding plate fixation screw 33, the holding plate 30 applies holding pressure to the fixation plate 15 toward the frame 20 so that the fixation plate 15 is pinched between the holding plate 30 and the frame 20. By this means, the fixation plate 15 is fixed, or pre-fixed, to the frame 20. However, the scope of this aspect of the invention is not limited to such an exemplary structure. For example, a coil spring(s), a flat spring(s), or other pressure-applying member may be used as a substitute for the holding plate fixation screw 33 so as to apply pressure to the holding plate 30 toward the frame 20 for the fixation of the holding plate 30. Even when such an alternative fixation means is used, the holding plate 30 applies holding pressure to the fixation plate 15 toward the frame 20 so that the fixation plate 15 is pinched between the holding plate 30 and the frame 20, thereby fixing, or pre-fixing, the fixation plate 15 to the frame 20.

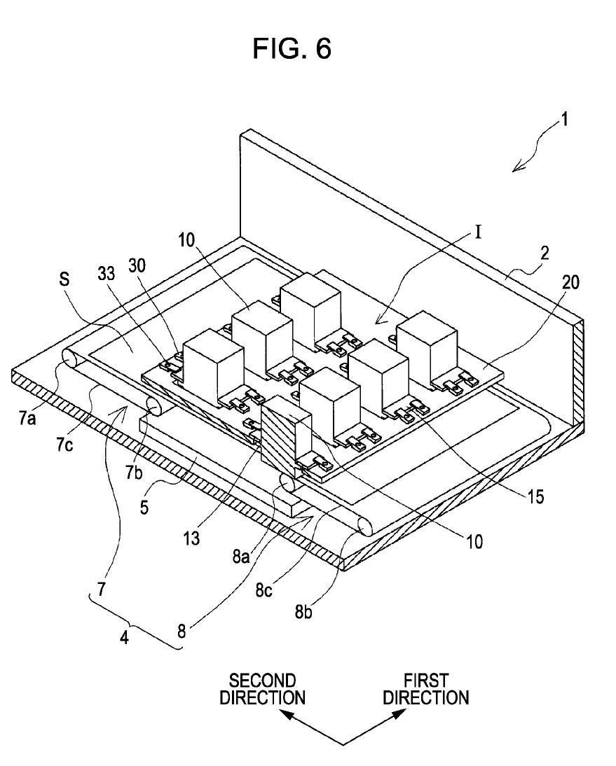

The ink-jet recording head I described above is mounted as a component of an ink-jet recording apparatus. FIG. 6 is a perspective view that schematically illustrates an example of the configuration of an ink-jet recording apparatus that is provided with an ink-jet recording head according to an exemplary embodiment of the invention.

As illustrated in FIG. 6, the ink-jet recording head I is mounted on an ink-jet recording apparatus 1, which is a so-called line-type recording apparatus. The line-type recording apparatus 1 performs printing on a recording target medium S such as a sheet of printing paper that is transported thereby. Specifically, the ink-jet recording apparatus 1 is provided with a body 2, the ink-jet recording head I that is fixed to the body 2, a recording target medium transportation means 4 that transports a sheet of printing paper S, and a cap member 5.

The ink-jet recording head I is fixed to the body 2 in such an orientation that the transporting direction of a sheet of printing paper S is the second direction defined earlier.

Though not shown in the drawing, the ink-jet recording head I is connected to ink containers such as ink tanks, ink cartridges, or the like. Ink is supplied from the ink containers to the ink-jet recording head I. The ink container can be provided at an arbitrary position. For example, the ink container may be provided above or over the ink-jet recording head I. Or, the ink container may be provided at any position inside the body 2 other than the position of the ink-jet recording head I.

The recording target medium transportation means 4 includes a first transporting means 7 and a second transporting means 8. The first transporting means 7 and the second transporting means 8 are provided in the neighborhood of the respective edge areas of the ink-jet recording head I that are opposite to each other when viewed in the transporting direction of a sheet of printing paper S, that is, the second direction.

The first transporting means 7 is made up of a driving roller 7a, a driven roller 7b, and a recording target medium transportation belt 7c. The endless transporting belt 7c is in roll contact with the driving roller 7a at one side and the driven roller 7b at the other side. Therefore, the transporting belt 7c is stretched between the driving roller 7a and the driven roller 7b. As in the configuration of the first transporting means 7, the second transporting means 8 is also made up of a driving roller 8a, a driven roller 8b, and a recording target medium transportation belt 8c.

Each of the driving roller 7a of the first transporting means 7 and the driving roller 8a of the second transporting means 8 is connected to a driving means such as a driving motor or the like. Note that the driving means is not illustrated in the drawing. Under the driving power that is transmitted from the driving means, each of the transporting belt 7c of the first transporting means 7 and the transporting belt 8c of the second transporting means 8 turns. By this means, a recording target medium transportation force is applied to a sheet of printing paper S each at the upstream of the ink-jet recording head I and at the downstream thereof.

As explained above, the ink-jet recording apparatus 1 is provided with the first transporting means 7, which is made up of the driving roller 7a, the driven roller 7b, and the transporting belt 7c, and the second transporting means 8, which is made up of the driving roller 8a, the driven roller 8b, and the transporting belt 8c. The ink-jet recording apparatus 1 may be further provided with a recording target medium holding means for holding a sheet of printing paper S on the transporting belts 7c and 8c. As an example of the holding means, an electrification means for electrifying the peripheral surface of a sheet of printing paper S may be provided. In such a configuration, the sheet of printing paper S electrified by the electrification means is held by suction on the transporting belts 7c and 8c due to dielectric polarization. As another example of the holding means, holding rollers may be provided over the transporting belts 7c and 8c. In such a configuration, the sheet of printing paper S is pinched between the holding rollers and the transporting belts 7c, 8c.

The cap member 5 is provided opposite to the ink-jet recording head I between the first transporting means 7 and the second transporting means 8. The cap member 5 functions as an ink catcher that catches an ink drop that is discharged at the time of the preliminary discharging operation of the ink-jet recording head I. In addition to the function of the ink catcher, the cap member 5 may further serve as a vacuuming means for sucking ink that remains inside the head body 10 through the nozzles 11. For example, the cap member 5 is provided as a movable member that can be brought into contact with the liquid ejecting surface of the ink-jet recording head I where nozzle holes are formed. In other words, the cap member 5 is provided in such a manner that it can be brought into contact with the surface of a nozzle plate of the ink-jet recording head I. A suction force application apparatus such as a vacuum pump or the like is connected to the cap member 5. The vacuuming apparatus applies a suction force to the cap member 5 when the cap member 5 is in contact with the discharging surface of the ink-jet recording head I where the nozzles 11 are formed. By this means, ink that remains inside the head body 10 is removed through the nozzles 11 due to the suction force.

Although FIG. 6 shows a line-type recording apparatus, the ink-jet recording apparatus 1 according to an exemplary embodiment of the invention is not limited thereto. For example, the ink-jet recording apparatus 1 may be embodied as such a type of ink-jet recording apparatus that moves the ink-jet recording head I in the direction orthogonal to the transporting direction of a sheet of printing paper S for printing.

The invention is directed to various kinds of liquid ejecting heads; and therefore, needless to say, the invention is also applicable to a variety of liquid ejecting heads that eject liquid other than ink. Accordingly, liquid ejecting heads to which the invention is applicable encompass a wide variety of heads; specifically, they include without any limitation thereto: a variety of recording heads inclusive of ink-jet recording heads that are used in an image recording apparatus such as a printer or the like, a color material ejection head that is used in the production of color filters for a liquid crystal display device or the like, an electrode material (i.e., conductive paste) ejection head that is used for the electrode formation of an organic EL display device or a surface/plane emission display device (FED, field emission display) and the like, a living organic material ejection head that is used for production of biochips.

What is claimed is:

1. A liquid ejecting head comprising:
a head body that includes a plurality of nozzles and ejects liquid drops from the nozzles;
a frame that supports the head body;
a fixation plate by means of which the head body is fixed to the frame; and
a holding plate that applies holding pressure to the fixation plate toward the frame so that the fixation plate is fixed to the frame.

2. The liquid ejecting head according to claim 1, further comprising a holding plate fixation screw and at least two washers, wherein the holding plate is fixed to the frame by means of the holding plate fixation screw; at least two washers mentioned above are provided between the holding plate and the holding plate fixation screw; and a coefficient of friction between one of the two washers and the other thereof is smaller than a coefficient of friction between the one washer and the holding plate, and in addition, is smaller than a coefficient of friction between the other washer and the holding plate fixation screw.

3. The liquid ejecting head according to claim 2, further comprising a fixation plate fixation screw, wherein the holding plate is fixed to the frame by means of the holding plate fixation screw; and the fixation plate is fixed to the frame by means of the fixation plate fixation screw.

4. A liquid ejecting apparatus that is provided with the liquid ejecting head according to claim 1.
